(19) United States
(12) Patent Application Publication
(10) Pub. No.: US 2009/0205019 A1
(43) Pub. Date: Aug. 13, 2009

(54) Mobile access to location-based community services

(75) Inventors: Georg Treu, Munich (DE); Ivar M.M. Vage, Icking (NO); Johannes Martens, Munich (DE)

Correspondence Address: NIXON & VANDERHYE, PC, 901 NORTH GLEBE ROAD, 11TH FLOOR, ARLINGTON, VA, 22203, US

(73) Assignee: u2nite Ltd. & Co.KG, Munchen (DE)

(21) Appl. No.: 12/068,972

(22) Filed: Feb. 13, 2008

(51) Int. Cl. G06F 15/16; G06F 21/00

(52) U.S. Cl. 726/4; 709/228

(57) ABSTRACT

The present invention discloses a method of accessing a network service via a mobile end device of a user in a wireless network wherein a first localisation procedure is performed in order to ascertain a position of the mobile end device. The availability of the network service is determined if the mobile and device is within or is about to enter a predetermined zone in which the network service is available. Then, the number of users of said network service in said zone is determined by using a second localisation procedure. Dependent on the number of users of the network service in said zone, one or more parameters for access of the network service by the mobile end user are set.

### FIELD OF INVENTION

The present invention relates to location-based community services, in particular a method of accessing such services via a mobile end device comprising density based access authorisation and processing. The invention is applicable but not limited to Web 2.0 types of services.

### TECHNICAL BACKGROUND

Existing community or network services of Web 2.0 such as facebook, OpenBC/Xing, LinkedIn or dating services are very popular and successful at the moment in the internet.

Such services enable their users to come into contact with other users, in part, in exchange for a fee. At the same there is currently a strong trend toward so-called Web 3.0 services, wherein such Web 2.0 types of services are adapted or modified for wireless and mobile end devices. Users of such services can thus adopt contact and exchange messages with other users who are located in the same geographical vicinity as them at a given time. An example of such free service is www.bluepulse.com. Another example is the mobile dating service www.meetmoi.com. However, although popular, such community services generally tend to offer a variety of services additionally comprising various premium i.e. cost-incurring options.

Until now, pricing has remained an unsolved problem of potential premium Web 3.0 services. High prices deter users from logging on with such services, especially when it is unclear as to how much actual usage the system attracts. This usage arises for the most part, from the number of other users logged on to the system who are in the geographical vicinity relative to the negotiating user.

However, if many other users are currently located in their vicinity, the potential usage of the system is relatively high and the user is sooner prepared to pay for the service.

A problem to be solved is therefore the population of such a service with paying users with the constraint of no user being in the system or in a particular geographical region.

### SUMMARY OF INVENTION

This problem is solved by the present invention as defined in claim 1.

### BRIEF DESCRIPTION OF THE DRAWINGS

FIG. 1 shows a schematic diagram of a method according to the present invention.

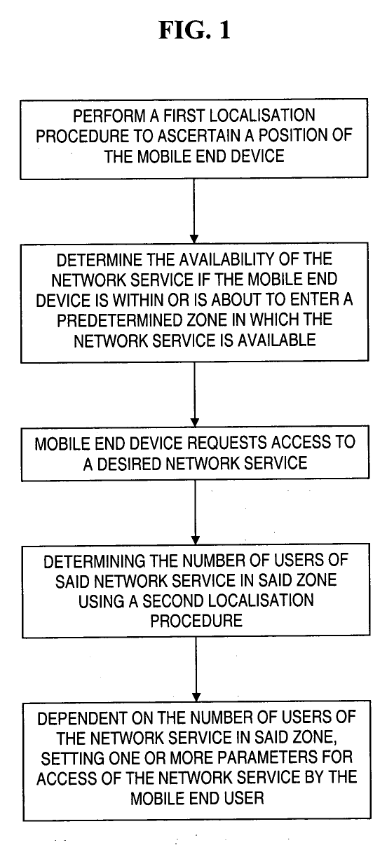

### DETAILED DESCRIPTION OF EMBODIMENTS OF THE INVENTION

An embodiment of the invention envisages making certain access parameters dependent on the number of users or user density of a particular geographical region. For example, if the number of users logged in to a particular service in the geographical area in which the user wishes to log in and get into contact with other users is small, then the fee for usage of the services would be calculated as being rather a small amount, or even nothing at all. Conversely, should many other users happen to be logged in to a particular community service and are located in a search range of a predetermined zone, then the user is subject to a higher fee i.e. dynamic pricing. For example one implementation of the present could be a dating service which would ultimately be accessed and used in a mobile manner i.e. on the go.

Preferably, before usage, the user receives an overview of the number of currently logged in users in particular areas (e.g. presented to the user according to the size of the district or quarter of town).

If the number is small, the user can redeem a “free-ticket” for access to the system with respect to that particular area. Further free tickets are then expended based on the additional new users accrued in a given area. If many users are already logged on in the area, a number over a particular threshold set by either the mobile/wireless device or system/service provider, all of the free tickets are expended. Therefore only premium log in services are available. Thus, the user in this case pays willingly since the chances to meet or get to know other users are very high.

One advantage of such “density based pricing” is that the price paid depends directly on the perceived usage of the user. The challenging initial phase is thus transcended by means of the free electronic tickets. Through the provision and availability of free electronic tickets, the user also gets the feeling of having got something for free, which, in comparison to a purely free service, a higher service appeal is possibly conveyed.

The term “pricing” in this context is intended not to relate to user charges only, but also to include other parameters that reflect the attractiveness or value of access to a service e.g. the period or spatial range of validity of access authorisation, the range of available services or even communication parameters such as available bandwidth.

More particularly, an embodiment of the present invention relates to a method of accessing at least one network service via a mobile end device of a user in a wireless network. Examples of such mobile end devices comprise mobile phones, laptops, PDAs, badges etc. although the scope of the invention is not intended to be limited in this respect.

A user of a particular network service in possession of a mobile end device located in a particular area wishes to log on to the service(s) and make contact with other users of the same network service(s). In order to do this, the mobile end device is activated and a log on procedure specific to the network service or services is performed. Prior to logging in, a first localisation procedure is implemented by means of communication between the mobile end device with a local service provider, through a local base station or wireless access point, in order to ascertain a position of the mobile end device.

This localisation procedure may be implemented from the side of the service provider or the mobile end device. The localisation procedure could also comprise a GPS-based or GSM-based procedure although the scope of the invention is not intended to be limited in this respect.

A number of predetermined zones, in which the mobile end device and the respective user thereof may be located, are associated with the particular network service which the mobile end device accesses. The predetermined zone in which the mobile end device and the user thereof is currently located upon attempting to access the service is determined upon actually logging on or attempting to log on to the particular network service.

In one embodiment of the present invention, this localisation procedure may be implemented by the service provider based on the location of the mobile end device. Alternatively, the localisation procedure may be determined by the mobile end device wherein it sends a message to a service provider indicating its location. Equally, once logged on, the determination as to whether a new zone has been entered (or left) can be made based on the aforementioned localisation procedure.

Likewise, the areas covered by the predetermined zones relating to the network service may be either determined by the mobile end device, the service provider or the network service. A predetermined zone could, for example correspond to a particular cell of a mobile phone network. Alternatively, a predetermined zone could also be associated with a particular district, or quarter of a downtown area, although the scope of the invention is not intended to be limited in this respect.

Upon logging on or attempting to log on to the network service, the zone in which the mobile end device is located is established by means of the localisation procedure further comprising a comparison of the user location with the location of the predetermined zone(s) associated with the network service or services.

Once the location of the mobile end device and particular predetermined zone in which it is located upon logging on or attempting to log on has been established, a further procedure then conducts an analysis of that predetermined zone. This analysis includes a further localisation procedure which aims to determine the number of other mobile end devices with respective users thereof which are currently logged in to the particular network service(s) in that predetermined zone i.e. which and how many other mobile end devices and respective users are located in the geographical vicinity of the initial mobile end device attempting to access the network service(s). The analysis thus provides a value representing the density population of mobile end devices and respective users of one (or more) network services within the predetermined zone.

In one embodiment of the present invention, such information would then be communicated to the initial mobile end device, either before or after an intial log on procedure. The user would then be made aware of the current usage of the particular network service in the predetermined zone in which they are located at the given time i.e. the number of other users logged on to the same network service(s) in the geographical vicinity of the initial user.

The network service would communicate with the initial mobile end device and the user will then be invited to either log on (if they have not already done so) to the network service or access this particular aspect of the network service (i.e. mobile contact with other active users) by means of an “electronic ticket” which enables authorisation and access to the network service for a predetermined amount of time.

The mobile device would need to “purchase” such a “ticket” in order to gain the relevant authorisation to the particular network service which would enable them to make contact with other users. The mobile device may need to obtain such a ticket when entering a new zone in which one or more desired community service(s) are operative.

The ticket itself, according to the present invention, may be considered to be electronic and any suitable means by which account information and privileges may be verified with respect to the given user. Such an electronic ticket may be associated with a fee, a period of validity, and/or a spatial range of validity. The fee is associated with the density of users in a particular zone. In this sense it may be inversely proportional to the density of users in a particular zone. The fee may also increase proportionally to the density of users in a particular zone. The fee may also be equal to zero i.e. a “free” electronic ticket. In a preferred embodiment of the present invention it is envisaged that the purchase of an electronic tickets is free of charge if there is less than a predetermined number of other users within the zone. In this case, as the number of logged on users increases and equals more than a predetermined number of users in said zone, then only fee-incurring electronic tickets would be available to new users wishing to access the network service.

In addition to being associated with the density, the ticket may also determine a period of time for which the mobile end device is authorised to use said at least on network service. This period of time may also be predetermined dependent on the density of users i.e. actual usage of the network service(s) in the predetermined zone at a given time for example, if there is a high density of users, then the initial user could be offered an electronic ticket for a limited period of time for a set fee. The set fee would be the same for the electronic ticket on another occasion when there are fewer other users online, but would be valid for a longer period of time.

In a preferred embodiment of the present invention, the density of users of the desired network service in the predetermined zone may include at least one group of users. In order to determine the fee or period or spatial range of validity of the electronic ticket to be purchased there are two-models. The first model is the so-called “one group model” as discussed above. The one group model involves the number of users being defined as a single group within the predetermined zone i.e. users of the same network service(s) as the user of the initial mobile end device. A further example of a definition of such a group of users could also be users of the same sex. In any case, the fee incurred for purchasing an electronic ticket to access the network services is based on purely the density of one particular group of users in the predetermined zone at a given time.

Affiliation of a user to a particular group may depend on various aspects, e.g. age, sex, user-defined preferences, relation to other members of the same group or other users of the same service, etc. Affiliation may also be predefined by the service operator.

Two Group Model

The so-called “two-group model” defines more than one group of users logged on to the particular network service(s). The two-group model may also define more than one group of users logged on to different, but related, network services. The definition of the groups may be predetermined by the network service(s), service provider, or the mobile end device itself.

In a preferred embodiment of the present invention, calculation of the fee, period of validity, and/or spatial range of an electronic ticket may be dependent on the ratio of users of at least two groups logged on to the network service(s) in a predetermined zone at a given time, to one another. The fee may in this case increase proportionally (linearly or non-linearly) to the ratio of one of the two groups to the other. The fee may also be inversely proportional to the ratio of one of the two groups to the other. As with the one-group model, the predetermined time period may also vary based on the ratio of one of the two groups to the other in a directly or inversely proportional manner. In a preferred embodiment of the present invention the two-group model may define, for example, male and female users as two different groups within the zone. For example, in the context of a dating service, if a new male user wishes to use that service in a zone where there are already ten other male users and only two female users, the price should be high, in order to avoid attracting even more male users. On the other hand, the price for a new female user may be set low, in order to attract more female users. In other words, the price for a new male user can be made proportional to the ratio of male/female users already in the zone. This price calculation may also be implemented vice-versa. For example, if there are more females than males then the price for a new male should be high because the service is more “attractive”.

In an alternative embodiment, three or more groups of users may be defined. In this embodiment, the fee and/or period of validity and/or spatial range of validity can be determined in accordance with the ratio of the three or more groups of users to one another.

The procedure according to the present invention concludes with the user of the initial mobile end device accepting the terms and conditions for purchasing an electronic ticket in order to achieve access to the desired network service. The mobile end device would then be issued with an electronic ticket thus authorising the user to access the network service for the offered period of time and/or spatial range.

In the above described embodiments, an access fee, period of validity, and/or spatial range of validity is determined dependent on user density. However, user density may also determine other access parameters e.g. relating to the range of available services, the authorisation to communicate directly with other users in a predetermined zone, the authorisation of different types of direct communication with other users in a predetermined zone (e.g. voice, SMS, MMS etc.).

1. A method of accessing a network service via a mobile end device of a
user in a wireless network, the method comprising:
performing a first localisation procedure to ascertain a position of the mobile end device;
determining the availability of the network service if the mobile end device is within or is about to enter a predetermined zone in which the network service is available;
determining the number of users of said network service in said zone using a second localisation procedure;
dependent on the number of users of the network service in said zone, setting one or more parameters for access of the network service by the mobile end user.

2. The method of claim 1 wherein the parameters for access of the network service comprise communication parameters that determine communications between the mobile end device and the network service and/or users of the network service.

3. The method of claim 1 wherein the parameters for access of the network service determine the pricing of the access of the network service by the mobile end device.

4. The method of claim 1 wherein the parameters for access of the network service determine a period of time for which access to the network service is authorised.

5. The method of claim 1 wherein the parameters for access of the network service determine a spatial range of validity in which access to the network service is authorised.

6. The method of claim 1 further comprising:
notifying the user of the number of users of the network service; and
prompting the user to indicate whether access to the network service is desired.

7. The method of claim 1 wherein entry into said predetermined zone by said mobile end device is determined by a service provider based on the location of the mobile end device.

8. The method of claim 1 wherein entry into said predetermined zone by said mobile end device is determined by the mobile end device sending a message to a service provider.

9. The method of claim 1 further comprising authorising the mobile end device to access said network comprising issuance of an electronic ticket to said mobile end device.

10. The method of claim 9 wherein the electronic ticket provides unrestricted and-or free access to the network service if the number of users of said network service is below a predetermined threshold.

11. The method of claim 10 wherein the number of electronic tickets which provide unrestricted access and-or free access is inversely proportional to the number of users in said zone.

12. The method of claim 9 wherein the issuance of said electronic ticket incurs a fee for the user of said mobile end device and/or provides restricted access only if there are more than a predetermined number of users in said zone.

13. The method of claim 12 wherein said fee and/or said access restrictions are determined dependent on the number of users.

14. The method of claim 13 wherein said fee and/or said access restrictions increase proportionally to the number of users.

15. The method of claim 12 wherein said fee and/or said access restrictions are dependent on the ratio of users of at least two groups to one another.

16. The method of claim 12 wherein said fee and/or said access restrictions increase proportionally to the ratio of one of the two groups to the other.

17. The method of claim 12 wherein said fee and/or said access restrictions increase inversely proportional to the ratio of one of the two groups to the other.

18. The method of claim 1 wherein the localisation procedure is a satellite based procedure, for example a GPS-based procedure.

19. A mobile network system adapted to enable a mobile end device to access a network service using the method steps of claim 1.

20. A computer program for a mobile network system adapted to enable a mobile end device to access a network service comprising code causing the system to perform the method steps of claim 1.
